(19) United States
(12) Patent Application Publication
(10) Pub. No.: US 2005/0005254 A1
(43) Pub. Date: Jan. 6, 2005

(54) Substrate noise analyzing method for semiconductor integrated circuit, semiconductor integrated circuit, and substrate noise analyzing device for semiconductor integrated circuit

(75) Inventors: Shouzou Hirano, Osaka (JP); Kenji Shimazaki, Hyogo (JP); Hiroyuki Tsujikawa, Shiga (JP)

Correspondence Address: McDERMOTT, WILL & EMERY, 600 13th Street, N.W., Washington, DC, 20005-3096, US

(73) Assignee: Matsushita Electric Industrial Co. Ltd.

(21) Appl. No.: 10/863,327

(22) Filed: Jun. 9, 2004

(30) Foreign Application Priority Data
Jun. 9, 2003 (JP) P.2003-163626

(51) Int. Cl. G06F 9/45

(52) U.S. Cl. 716/5

(57) ABSTRACT

In substrate noise analysis for a semiconductor integrated circuit, it takes long to calculate the amount of current input to the substrate and substrate potential fluctuations in an analog circuit to which the current is propagated in combination with impedance/power supply resistance of the substrate including a large scale RC circuit network. The amount of calculation is reduced in calculating current passed to power supply/ground by adding triangles having areas corresponding to power consumption separately for rising/falling in logical changes in gate level simulation. The amount of calculation is reduced by summing current, interface capacitance, interface resistance, power supply resistance, ground resistance, power supply voltage fluctuations, and ground voltage fluctuations on a basis of block, instance or simultaneous operation. Since the calculation amount is reduced, it takes a shorter period to apply substrate noise analysis. In addition, the elements for calculation are also reduced, and therefore substrate noise analysis can be applied to a large scale semiconductor integrated circuit.

The present application is based on Japanese Patent Application No. 2003-163626, which is incorporated herein by reference.

### BACKGROUND OF THE INVENTION

1. Field of the Invention

The present invention relates to an analyzing technique for a semiconductor integrated circuit, and more particularly to a substrate noise analyzing method by simulation related to noise through substrate impedance in a semiconductor integrated circuit and a substrate noise analyzing device that carries out the method. The invention also relates to a semiconductor integrated circuit device subjected to the process by the substrate noise analyzing method

2. Description of the Related Art

In forming a semiconductor integrated circuit, impurity is diffused on a semiconductor substrate to form elements, while layers of metal are placed to form interconnections, and in this way, circuits are integrated. The circuit elements are electrically connected with one another through the semiconductor substrate, so that potential fluctuations at the substrate generated by the operation of a circuit element are propagated to other circuit elements, and affect them as substrate noise.

In recent years, an enormous number of circuits are integrated, and the magnitude of the substrate noise has increased accordingly. In a system LSI having various functions provided in a single semiconductor integrated circuit in particular, both digital and analog circuits are provided on the same semiconductor substrate, and therefore the performance of the analog circuits is greatly degraded by the substrate noise. The noise that could affect audio and video qualities is recognized after the semiconductor integrated circuit is completed, which has come to be a serious problem.

Meanwhile, a typical countermeasure to the problem is a substrate noise analyzing method according to which simulation by a simulator that estimates current/voltage to be generated in a semiconductor circuit and impedance in the semiconductor substrate are combined for estimating the substrate noise. In this way, the noise can be reduced in advance.

An example of how the conventional noise analysis works is shown in FIG. 17.

In this example, the P/N junctions between the source-drain region of a transistor and the substrate and between N-well and the substrate are expressed in terms of capacitance and the regions between them and between them and the power supplies are represented by resistors in an equivalent circuit.

FIG. 16 is an example of the system LSI to which analyzing process according to the invention is to be applied.

FIG. 16 is an example of the case in which a twin-well type transistor is formed on a P-type silicon substrate Psubstrate.

A typical system LSI includes digital circuits and analog circuits.

CMOS is usually used for the system LSI, and the digital and analog circuits are made of P-channel transistors DPchTr and APchTr and N-channel transistors DNchTr and ANchTr. The P-channel transistors are formed in N-wells DNwell and ANwell. Capital letters D and A of DpchTr and ApchTr respectively mean Degital and Analog.

Some transistors are connected to the power supplies DVDD and AVDD and grounds DVSS and AVSS.

In the vicinity of the transistors, substrate contacts DPsubcon, DNsubcon, APsubcon, and ANsubcon are formed in order to stabilize the operation-of the transistors.

The P-type substrate contacts DPsubcon and APsubcon are formed in the P-substrate Psubstrate and connected to the corresponding grounds DVSS and AVSS, respectively.

The P-type substrate contacts are provided to stabilize the N-channel transistors.

The N-type substrate contacts DNsubcon and ANsubcon are formed in the N-substrate Nsubstrate and connected to power supplies DVDD and AVDD, respectively.

The N-type substrate contacts are used to stabilize the P-channel transistors.

The digital circuit is adapted to operate in synchronization with an externally applied, periodical clock signal, an inverter and a buffer that propagate the clock signal and a flip-flop as a sequential circuit for causing synchronized operation are operated substantially simultaneously, so that large current is passed to the power supply DVDD and the ground DVSS.

The current is transmitted to the substrate of the transistors ANchTr and APchTr in the analog circuit through the substrate contacts DPsubcon and DNsubcon or the sources of the transistors DNchTr and DPchTr and thus makes the operation unstable. In addition, fluctuations in the power supplies or grounds vibrate the substrate through the substrate contacts DPsubcon and DNsubcon and the sources of the transistors DNchTr and DPchTr in the digital circuit, which vibrates the substrate Psubstrate. The vibration is then transmitted to the analog circuit. This vibration is transmitted to the substrate of the transistors ANchTr and APchTr in the analog circuit and makes the operation of the transistors unstable.

As a result, clock signals generated by a PLL that is often used for an analog configuration can be unstable or the conversion precision of the analog-digital (A/D) conversion circuit can be degraded. This is a serious problem particularly in a high density, large scale system LSI whose power supply current and power supply fluctuations are great.

The conventional substrate noise analyzing method as shown in FIG. 17 takes long processing time to deal with current coming from a large number of circuit elements and substrate contacts. Meanwhile, according to Unexamined Japanese Patent Publication No. 2002-158284, information on substrate contacts on the ground side is reduced on a mesh division basis. The mesh is divided on a functional block basis also according to the method.

The method however employs a method of summing only ground current and contact resistance on a mesh basis related to the substrate structure, and substrate noise caused by combinations of fluctuations of circuit elements and power supplies cannot be expressed well. Furthermore, information on substrate contacts must be summed on a substrate mesh basis. Therefore, once the position of the substrate contacts is changed for reducing the substrate noise, information must be summed all over again.

### SUMMARY OF THE INVENTION

It is an object of the invention to provide a substrate noise analyzing method that allows substrate noise caused by combinations of fluctuations in power supply current, ground current, power supplies, grounds and circuit elements to be analyzed at high speed.

According to the invention, current/impedance related to fluctuations in circuit elements and fluctuations in power supplies is summed on a region/block/simultaneous change basis independently of the substrate mesh.

### BRIEF DESCRIPTION OF THE DRAWINGS

In the accompanying drawings:

FIGS. 1 to 4 are flowcharts for use in illustration substrate noise analyzing methods according to first to fourth embodiments of the invention;

FIGS. 5 to 8 are operation charts for use in illustration of the operation of identification means according to fifth to eighth embodiments of the invention;

FIGS. 9 to 11 are operation charts for use in illustration of the operation of current combining means according to ninth to eleventh embodiments of the invention;

FIGS. 12 and 13 are operation charts for use in illustration of interface capacitance combining means according to an eleventh embodiment of the invention;

FIG. 14 is an operation chart for use in illustration of resistance combining means according to a twelfth embodiment of the invention;

FIG. 15 is an operation chart for use in illustration of current combining means according to the tenth embodiment of the invention;

FIG. 16 is a diagram for use in illustration of a system LSI to which the analyzing method according to the invention is applied;

FIG. 17 is a diagram showing LSI modeling by conventional substrate noise analysis;

FIG. 18 is a chart for use in illustration of signal transition information according to the first embodiment of the invention;

FIG. 19 is a diagram for use in illustration of the number of logical stages according to the second embodiment of the invention;

FIG. 20 shows a circuit element logical stage number library according to the second embodiment of the invention; and

FIG. 21 shows a circuit element power supply/ground current library according to the third embodiment of the invention.

### DETAILED DESCRIPTION OF THE PREFERRED EMBODIMENTS

First to third embodiments of the invention are related to a method of calculating power supply and ground current at high speed.

A fourth embodiment of the invention is related to a method of calculating current passed through a substrate from circuit elements at high speed.

Fifth to eighth embodiments of the invention are related to a method of summing information based on simultaneous fluctuations, blocks, names, and regions.

Ninth to twelfth embodiments of the invention are related to a method of summing circuit element current, power supply-ground current, junction capacitance, interface resistance, and power supply-ground resistance in the above described summing ranges.

(First Embodiment)

The first embodiment of the invention will be described. According to the embodiment, current forms at the ground or power supply are estimated based on fluctuations in the logical values in digital simulation or functional simulation in order to increase the speed of analyzing substrate noise.

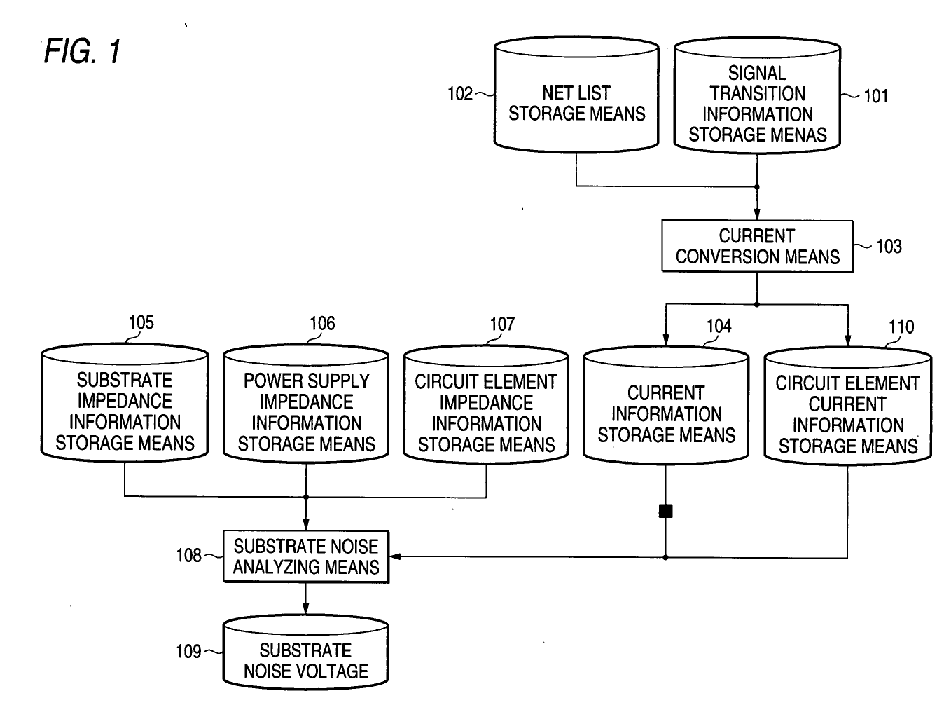

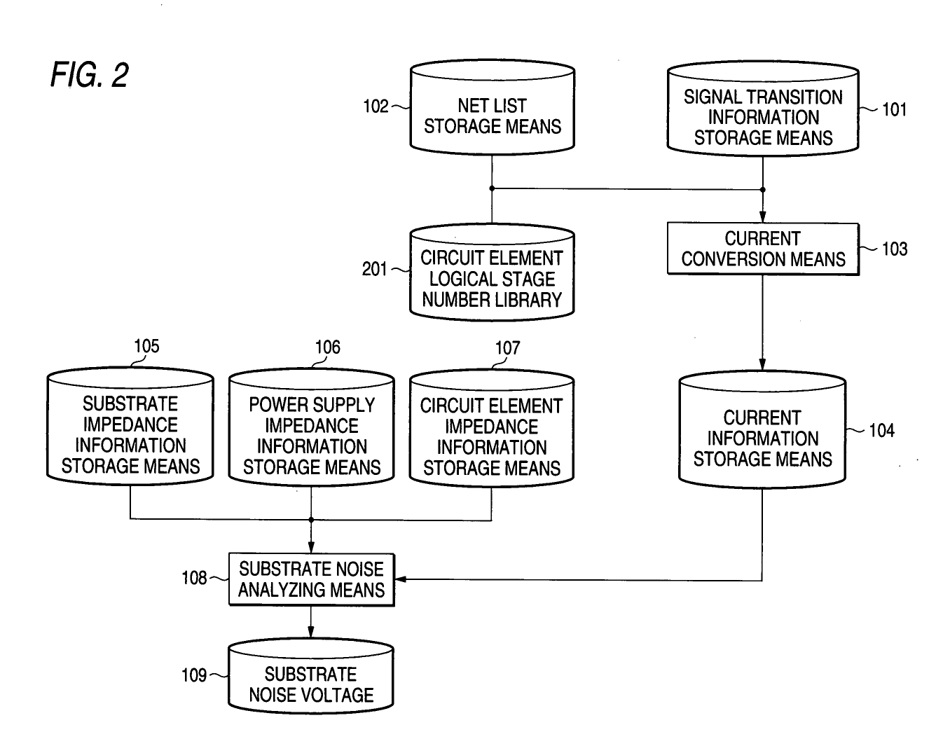

FIG. 1 shows the first embodiment.

Current conversion means 103 reads line capacitance made of the parasitic capacitance information of output lines of the circuit elements and/or information on the next stage circuit elements from net list storage means 102 that stores the net list of a semiconductor integrated circuit to be analyzed. Then, the current conversion means 103 converts the line capacitance into current fluctuations on the power supply side and ground side based on signal transitions between the logical states 0 and 1 at the output terminals of the circuit elements read from signal transition information storage means 101 that stores the signal transitions at the output terminals of the circuit elements.

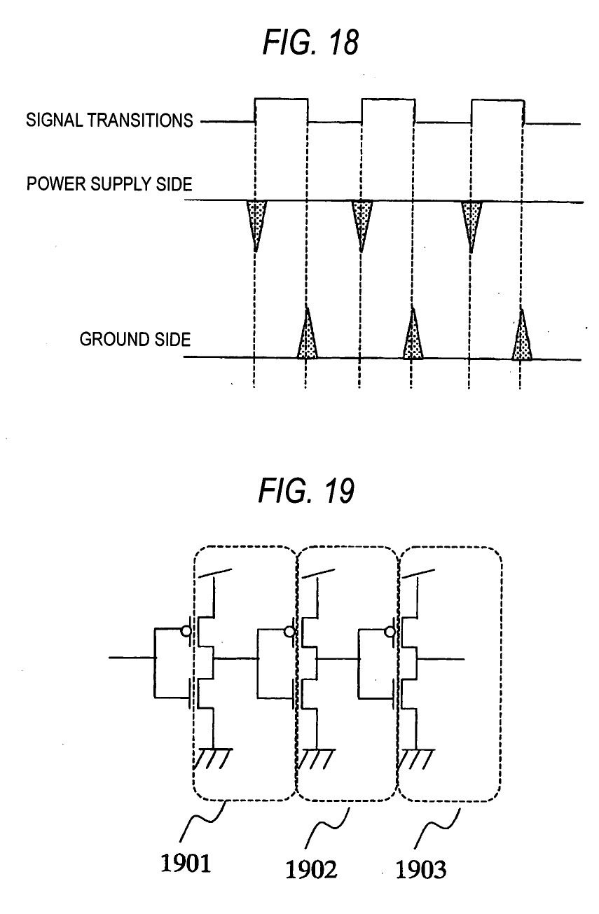

For example when a signal transition as shown in FIG. 18 is provided, a current waveform that expresses passage of current to store charge to the line capacitance is generated when the logical state changes from 0 to 1. The wave form may have current consumption obtained based on the line capacitance as an area and may be in the shape of a triangle, a rectangle, an irregular pentagon (like a Japanese chess (Shogi) piece), or the like. The triangles are shown in FIG. 18.

On the ground side, a current waveform to express passage of current to discharge from the line capacitance is generated when the logical state changes from 1 to 0.

These waveforms are stored in current information storage means 104 that stores the waveforms of power supply and ground current, and also stored in circuit element current information storage means 110 that stores the waveforms of current coming into the substrate from the source and drain terminals of transistors connected to the power supply and ground.

Substrate impedance information storing means 105 stores substrate impedance information extracted from layout information, power supply impedance information storing means 106 stores power supply impedance information, and circuit element impedance information storing means 107 stores impedance between the source-drain terminal and the substrate in a circuit element. Substrate noise analyzing means 108 reads these kinds of impedance information and current information and calculates voltage fluctuations generated in the substrate for the analog circuit elements, and substrate noise voltage storing means 109 stores the calculation result.

In the disclosure of Japanese Patent Publication No. 2002-158284, ground current calculated based on power consumption obtained from the number of transitions is simplified for a single node. However, unless current fluctuations at the ground and power supply are accurately modeled in time series, the accuracy of such substrate noise analysis based on the effect represented by a series of ground and power supply fluctuations could be considerably low.

According to the embodiment, this disadvantage can be solved.

(Second Embodiment)

The second embodiment of the invention will be described. In place of the first embodiment, the second embodiment is directed to a method of estimating the current waveform at the ground and the power supply based on library information having the number of logical stages in a cell.

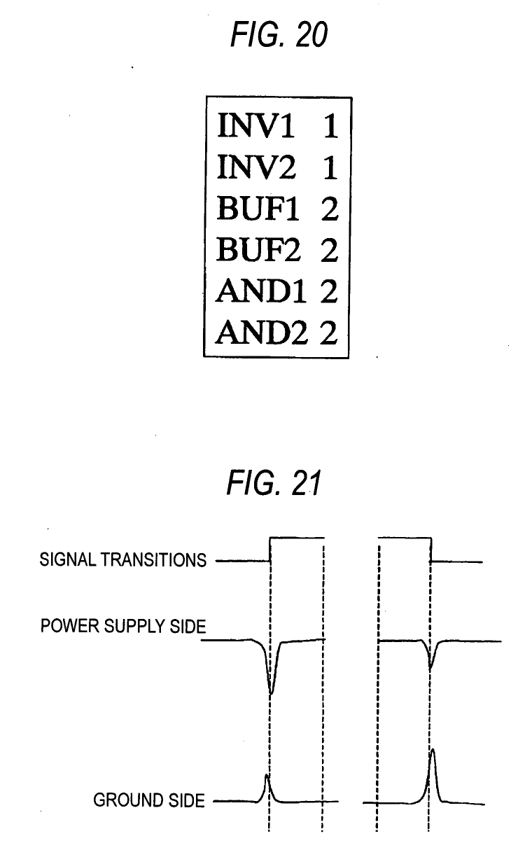

The number of logical stages is defined as the number of channel-connect structures (CCC). For example, three stages of inverters as shown in FIG. 19 can be separated into 1901, 1902, and 1903 as structures connected through channels (separated by gates) In this case, the number of logical stages is three. The number of logical stages is previously formed into a library on a logical element basis as shown in FIG. 20, and stored in the circuit element logical stage number library storing means 201. When current is calculated by the current conversion means 103 using the logical stage number information, current fluctuations generated in a internal logical element is calculated. More specifically, when the output line of the logical element changes from 0 to 1, the interconnection in the logical elements as many as the number produced by rounding up (logical stage number −1)/2 to be an integer changes from 1 to 0, and current values on the ground side and on the power supply side are calculated in the same manner as the first embodiment.

When the output line of the logical element changes from 1 to 0, it is assumed that the interconnection in the logical elements as many as the number produced by rounding up (logical stage number −1)/2 to be an integer changes from 0 to 1, and current values on the power supply side and on the ground side are calculated in the same manner as the first embodiment.

By this method, current fluctuations can accurately be expressed for a circuit element having a large number of stages and the substrate noise can accurately be dealt with.

(Third Embodiment)

The third embodiment of the invention will be described. In place of the first embodiment, the third embodiment is directed to a method of estimating the current waveform at the ground and the power supply based on library information.

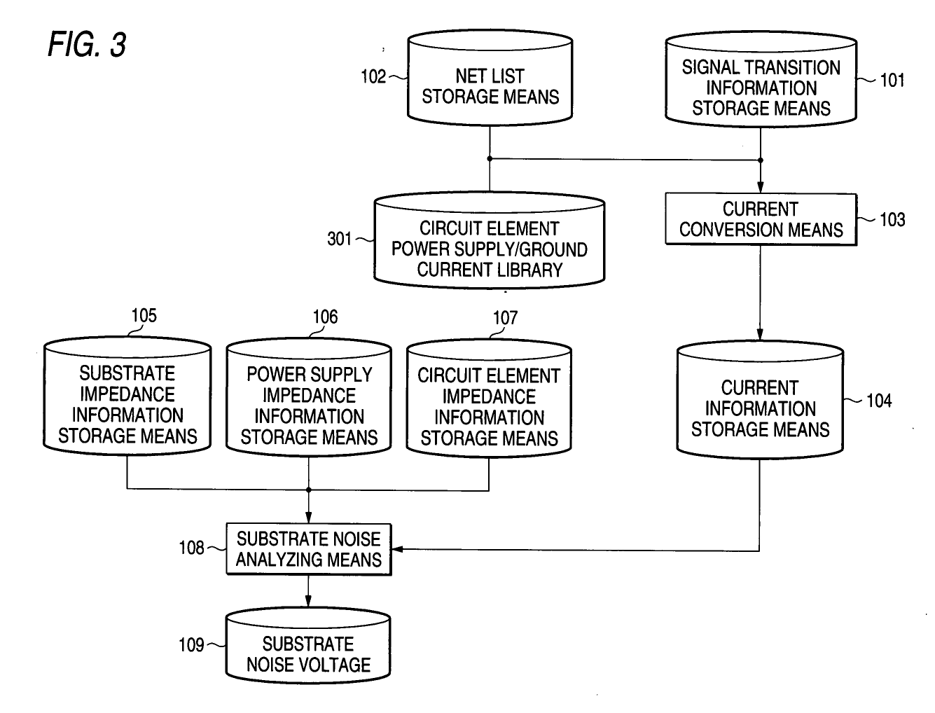

As shown in FIG. 21, current passed to the power supply side and to the ground side during the signal transition from 0 to 1 or from 1 to 0 is previously examined on a circuit element-basis, and the result is stored in a circuit element power supply/ground current library 301 in FIG. 3.

Current values for the power supply and ground of the individual logical elements are added in synchronization with change at the output terminals of the logical elements by the current conversion means, and the result is stored in the current information storage means 104 as the current waveforms of the power supply and ground.

By this method, current fluctuations can accurately be dealt with, and the substrate noise can accurately be dealt with.

(Fourth Embodiment)

The fourth embodiment of the invention will be described. The fourth embodiment is directed to a method of treating charge/discharge current to interface capacitance (junction capacitance between the source-drain diffusion region and the well region of a transistor) among power supply/ground current as substrate current applied from the source-drain terminals of P-channel and N-channel transistors.

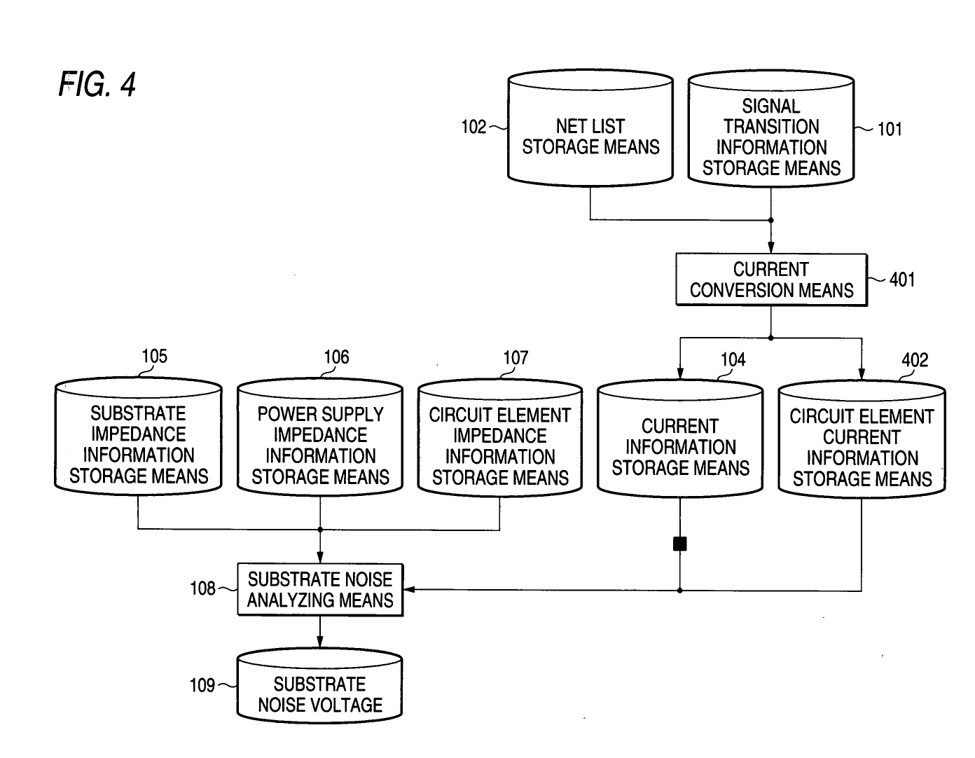

According to the embodiment, similarly to the first embodiment, when current is estimated using current conversion means 401 shown in FIG. 4, a current waveform removed of the effect of line capacitance is calculated in circuit element current information storage means 402. More specifically, when the current waveform is estimated, current coming into the line capacitance is not added.

By this method, the current waveform can be estimated highly precisely.

(Fifth Embodiment)

The fifth embodiment of the invention will be described. According to the embodiment, information on circuit elements that fluctuate substantially at the same time is summed into one circuit element.

By this method, information is summed by determining data to be summed before or after the current waveform estimation by the current conversion means. Before the waveform estimation, processing can be carried out without unnecessary intermediate files. After the estimation, such an intermediate file is necessary, but the manner of summing can be changed later. In other words, the manner can be switched depending on the purpose.

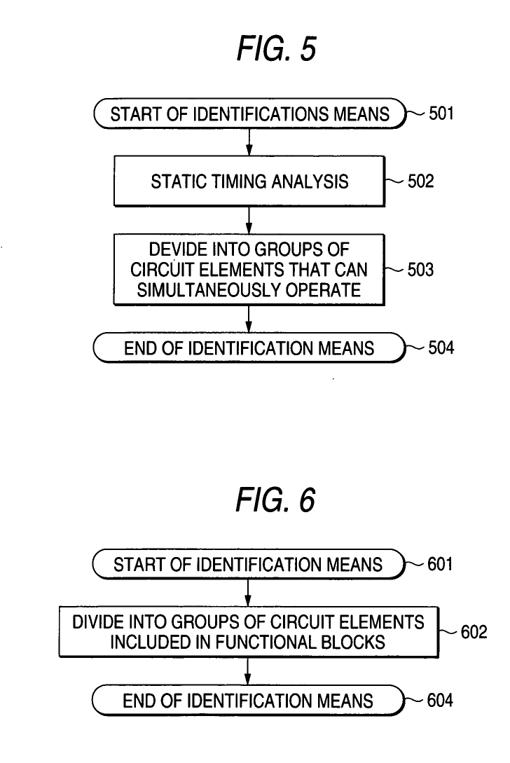

As shown in FIG. 5, the method of determining data to be summed starts to be carried out by the start of identification means (501). Circuit elements likely to have signal transitions for a predetermined time period are searched for based on timing information in the static timing analysis (502) or signal transition information resulting from simulation in a dynamic simulator, and division (503) into groups of circuit elements that can simultaneously operate is carried out. The resultant list is stored as sequential identification information, and the process ends with the end of identification means (504).

The summing operation using the information is carried out before or after the current waveform estimation, so that the information to be dealt with in the substrate noise analysis is reduced, and the processing speed can be increased.

(Sixth Embodiment)

The sixth embodiment of the invention will be described. The embodiment is directed to a method of summing data on a functional block basis.

As shown in FIG. 6, the method of determining data to be summed is carried out by the start of identification means (601), circuit elements included in functional block information, division (602) into the groups of circuit elements included in the functional block information is carried out and the resultant list is stored as sequential identification information, and the process ends with the end of identification means (603).

The summing operation using the information may be carried out before or after the current waveform estimation, so that information dealt with in the substrate noise analysis can be reduced and the processing speed can be increased.

(Seventh Embodiment)

The seventh embodiment of the invention will be described. The embodiment is directed to a method of summing on a basis of information on part of names.

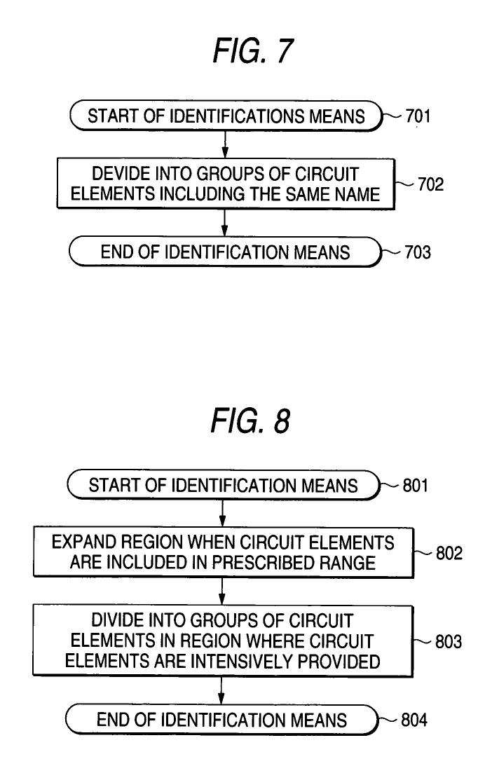

As shown in FIG. 7, the method of determining data to be summed starts with the start of identification means (701), circuit elements whose names have the same head part are searched for, and division (702) into the groups of circuit elements including the same name is carried out. The resultant list is stored as sequential identification information, and the process ends with the end of the identification means (703).

The summing operation using the information may be carried out before or after the current waveform estimation, so that the information treated in the substrate noise analysis can be reduced and the processing speed can be increased.

(Eighth Embodiment)

The eighth embodiment of the invention will be described. The embodiment is directed to a method of summing on a basis of a region in which circuit elements and substrate contacts are intensively provided.

As shown in FIG. 8, the method of determining data to be summed starts with the start of identification means (801), region expansion (802) is carried out when circuit elements are included in a prescribed range, and regions where circuit elements and substrate contacts are intensively provided are searched for. Division (803) into groups of circuit elements in the regions where circuit elements and substrate contacts are intensively provided is carried out, the resultant list is stored as sequential identification information and the process ends with the end of the identification means (804).

The summing operation using the information may be carried out before or after the current waveform estimation, so that the information treated in the substrate noise analysis can be reduced and the processing speed can be increased.

(Ninth Embodiment)

A ninth Embodiment of the invention will be described. The embodiment is directed to a method of summing circuit element current.

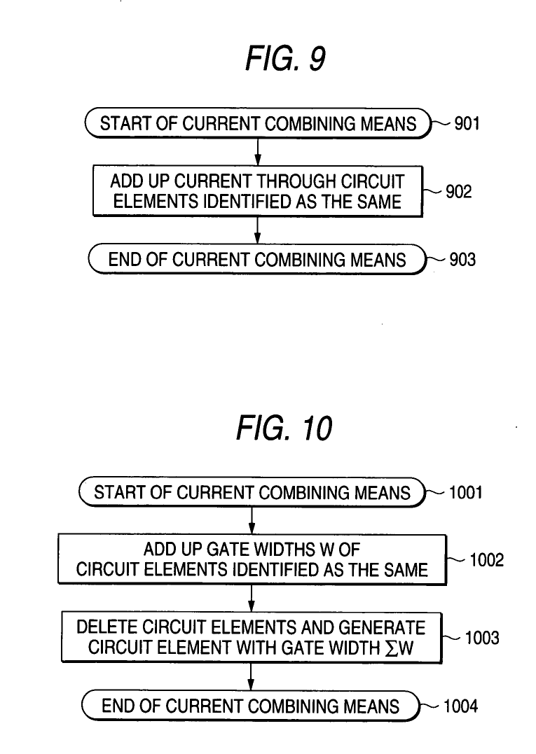

As shown in FIG. 9, the process starts with the start of current combining means (901), current for circuit elements identified as the same based on the identification information is added up (902), and the process ends with the end of current combining means (903). The accumulation result is treated as representative current information.

In an alternative way, as shown in FIG. 10, the process starts with the start of current combining means (1001), the gate widths W of circuit elements identified as the same are added up (1002). Then, the circuit elements identified as the same are deleted, and a circuit element having a gate width ΣW is generated (1003), and the process ends with the end of the current combining means (1004). The same object can be achieved by replacing the elements with the circuit element produced by adding up in this way.

(Tenth Embodiment)

The tenth embodiment of the invention will be described. The embodiment is directed to a method of summing power supply/ground current.

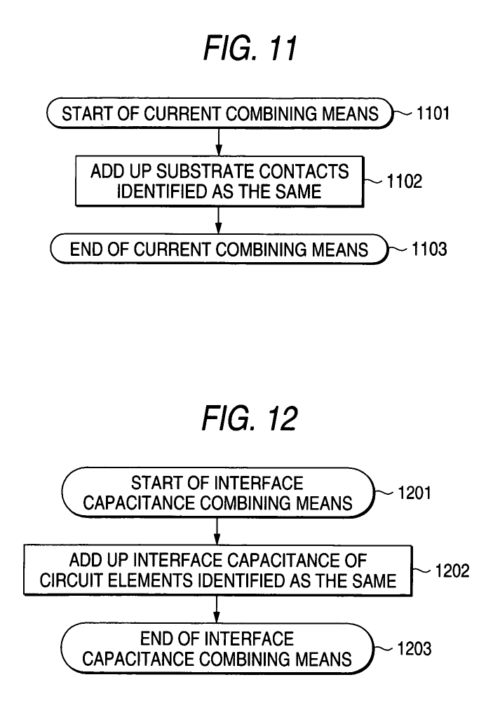

As shown in FIG. 11, the process starts with the start of current combining means (1101), current amounts for substrate contacts identified as the same based on the identification information are added up (1102), and the process ends with the end of the current combining means (1103). The accumulation result is treated as representative current information.

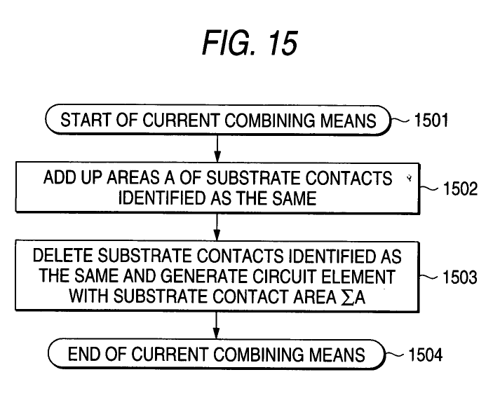

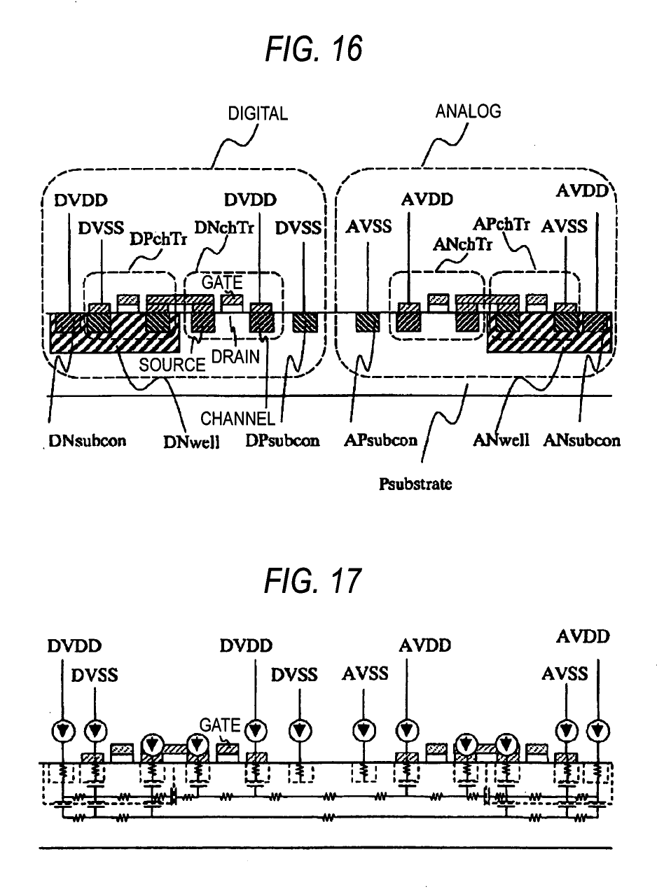

In an alternative way, as shown in FIG. 15, the process starts with the start of current combining means (1501), the areas A of substrate contacts identified as the same based on the identification information are added up (1502), the substrate contacts identified as the same are deleted and a circuit element having a substrate contact area ΣA is generated (1503), and the process ends with the end of the current combining means (1504). The same object can be achieved by replacing the substrate contacts with the substrate contact produced by adding up in this way.

(Eleventh Embodiment)

The eleventh embodiment of the invention will be described. The embodiment is directed to a method of summing interface capacitance.

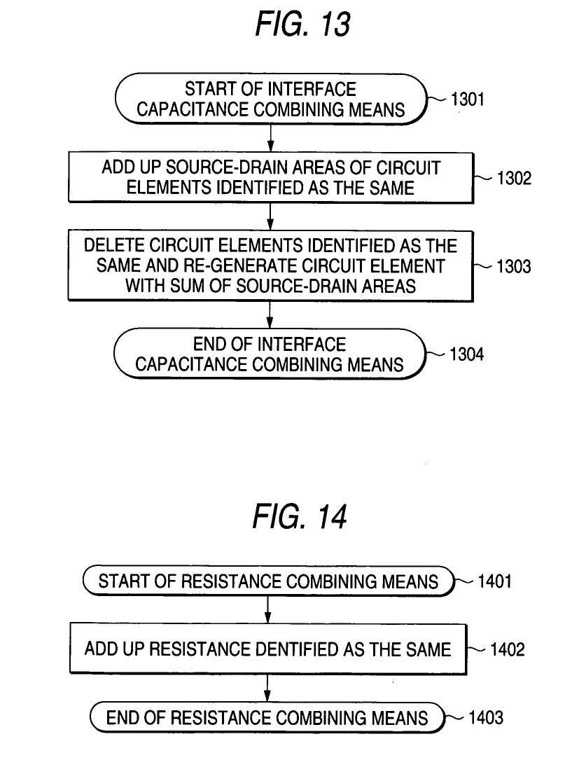

As shown in FIG. 12, the process starts with the start of interface capacitance combining means (1201), the amounts of the interface capacitance of circuit elements identified as the same based on the identification information are added up (1202), and the process ends with the end of the interface capacitance combining means (1203). The accumulation result is treated as representative capacitance information. In an alternative way, as shown in FIG. 13, the process starts with the start of the interface capacitance combining means (1301), the source-drain areas of circuit elements identified as the same based on the identification information are added up (1302), and the circuit elements identified as the same are deleted. A circuit element having the sum of the source-drain areas as the area is generated (1303), and the process ends with the end of the interface capacitance combining means (1304). In this way, the same object can be achieved by replacing with the source-drain area produced by adding up in this way.

(Twelfth Embodiment)

The twelfth embodiment of the invention will be described. The embodiment is directed to a method of summing power supply/ground resistance.

As shown in FIG. 14, the process starts with the start of the resistance combining means (1401), the amounts of resistance of resistors identified as the same based on the identification information are added up (1402), power-supply/ground resistance is added, and the process ends with the end of the resistance combining means (1403) The accumulation result is treated as representative-resistance information.

According to the invention, a method of analyzing substrate noise caused by the combinations of power supply/ground fluctuations and circuit element fluctuations at high speed can be provided.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

1. A substrate noise analyzing method comprising a step of summing any one of power supply current, ground current, current input from a circuit element to a substrate, junction capacitance between power supply, ground, the circuit element and the substrate, interface resistance between the power supply, the ground, the circuit element, and the substrate, power supply resistance, ground resistance, power supply voltage fluctuations, and ground voltage fluctuations, said summing step being independent of an analyzing structure for the substrate.

2. The substrate noise analyzing method according to claim 1, wherein said summing step comprises a first step of estimating the form of current at the ground and the power supply based on changes in the logical value in digital simulation or functional simulation and logical circuit information.

3. The substrate noise analyzing method according to claim 1, wherein said summing step comprises a second step of estimating the form of current at the ground and the power supply based on changes in the logical value in digital simulation or functional simulation and logical element stage number information.

4. The substrate noise analyzing method according to claim 1, wherein said summing step comprises a current waveform library step of preparing a library of power supply current waveforms and ground waveforms for changes in the logical value of the circuit element; and
a third step of estimating the form of current at the ground and the power supply based on the current waveform information prepared in said library.

5. The substrate noise analyzing method according to claim 1, wherein said summing step comprises the step of estimating substrate current, in said estimating step, the power supply current and the ground current for charge/discharge to/from interface capacitance are treated as substrate current applied from the source-drain terminals of a P-channel transistor and an N-charnel transistor, respectively.

6. The substrate noise analyzing method according to claim 5, wherein in said substrate current estimating step, it is assumed that the power supply current and ground current for charge/discharge to/from said interface capacitance are applied from N-well and P-well regions, respectively in the circuit element.

7. The substrate noise analyzing method according to claim 1, wherein said summing step comprises the step of summing for circuit elements fluctuating substantially at the same time.

8. The substrate noise analyzing method according to claim 1, wherein said summing step comprises summing on a functional block basis.

9. The substrate noise analyzing method according to claim 1, wherein said summing step comprises summing on a basis of information on part of names.

10. The substrate noise analyzing method according to claim 1, wherein said summing step comprises summing on a basis of a region where circuit elements and substrate contacts are intensively provided.

11. The substrate noise analyzing method according to claim 1, wherein said summing step comprises summing circuit element current.

12. The substrate noise analyzing method according to claim 1, wherein said summing step comprises summing power supply/ground current.

13. The substrate noise analyzing method according to claim 1, wherein said summing step comprises summing interface capacitance.

14. The substrate noise analyzing method according to claim 1, wherein said summing step comprises summing interface resistance.

15. The substrate noise analyzing method according to claim 1, wherein said summing step comprises summing power supply/ground resistance.

16. The semiconductor integrated circuit device having its substrate noise analyzed by the substrate noise analyzing method according to any one of claims 1 to 15.

17. The substrate noise analyzing device for a semiconductor integrated circuit operating to carry out the substrate noise analyzing method according to any one of claims 1 to 15.
